(19) United States
(12) Patent Application Publication
(10) Pub. No.: US 2010/0193685 A1
(43) Pub. Date: Aug. 5, 2010

(54) Miniature Neutron Generator for Active Nuclear Materials Detection

(75) Inventors: Wei-kan Chu, Pearland, TX (US); Jiarui Liu, Pearland, TX (US)

Correspondence Address: AKIN GUMP STRAUSS HAUER & FELD LLP, 1111 Louisiana Street, 44th Floor, Houston, TX, 77002, US

(73) Assignee: UNIVERSITY OF HOUSTON, Houston, TX (US)

(21) Appl. No.: 11/993,684

(22) PCT Filed: Jun. 29, 2006
(86) PCT No.: PCT/US2006/025607

§ 371 Date: Jan. 30, 2008

Related U.S. Application Data
(60) Provisional application No. 60/695,368, filed on Jun. 29, 2005.

(51) Int. Cl. G01N 23/00; G21B 1/00

(52) U.S. Cl. 250/306; 376/108

(57) ABSTRACT

This miniature neutron generator is for active detection of highly enriched uranium using a movable detection system. It is a small size, lightweight, low power consumption neutron generator with ease of operation and maintenance. The detector is based on a simplified ion source and ion transport system.

### STATEMENTS REGARDING FEDERALLY SPONSORED RESEARCH OR DEVELOPMENT

None.

### REFERENCE TO A MICROFICHE APPENDIX

None.

### BACKGROUND OF THE INVENTION

1. Field of the Invention

This invention relates to the use of a miniature neutron generator for active detection of highly enriched uranium (“HEU”) with movable detection systems.

2. Description of the Related Art

One of the most challenging problems in Homeland Security is the detection technique for mass destruction and other contraband. This invention is for a promising technique to detect nuclear materials and in particular weapon-usable materials like HEU and Weapon Grade Plutonium (“WGPu”).

For active detection of HEU with movable detection systems, small size, lightweight neutron generators and detectors are necessary.

### BRIEF SUMMARY OF THE INVENTION

This miniature neutron generator is for active detection of HEU using a movable detection system. It is a small, lightweight, low power consumption neutron generator with ease of operation and maintenance. The detector is based on a simplified ion source and ion transport system.

In one aspect, the invention provides a neutron generator that includes a Deuterium gas filled chamber, a high voltage power supply, a field ionization ion source, at least one of a carbon nano-tube, nano-rod or multi-pin tungsten anode and a cathode;

In another aspect of the invention, a neutron generator is provided that comprises a Deuterium gas filled chamber, a high voltage power supply of 125-150 kV, an ionization source comprising tungsten tips, an anode and a Tritium loaded Titanium thick target, wherein the generator weighs less than 10 kilograms;

In a further aspect of the invention, a method of detecting highly enriched Uranium associated with a target is provided that includes generating a field ionization of Deuterium by high voltage electric field, providing an ion current, accelerating the ions to hit the target to generate a Deuterium-Tritium reaction and collecting and analyzing the data.

In yet a further aspect of the invention, a method of detecting highly enriched Uranium associated with a target is provided that comprises generating a high voltage electric field using at least one of carbon nano-tube, nano-rod or multi-pin tungsten anode, providing an ion current using a field ionization source, accelerating the ion current such that the ion current hits the target to generate Deuterium-Tritium neutrons, wherein the ion current is accelerated up to 125-150 kV and collecting and analyzing the data.

### BRIEF DESCRIPTION OF THE SEVERAL VIEWS OF THE DRAWINGS

FIG. 1. is a schematic of the small neutron generator of the invention.

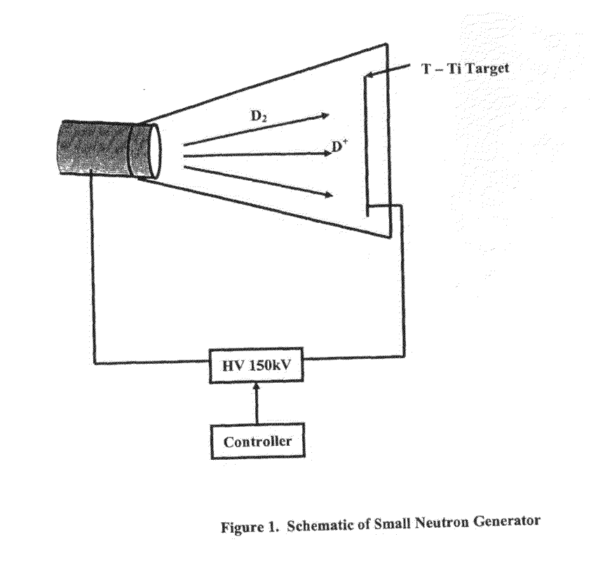

### DETAILED DESCRIPTION OF THE INVENTION

In this invention, a miniature neutron generator is developed for the neutron yield of 10⁹ n/second. The ion source of this neutron generator is a field-ionization ion source. An anode of carbon nano-tubes (“CNT”) or nanorods (“NR”) or metal multi-tips is used for ion beam production up to a mili-Amp or more in a Deuterium gas-filled chamber. A Tritium loaded Titanium (“T-Ti”) thick target is located at the other end of the chamber as the cathode. A high voltage (“HV”) power supply is applied between the anode and the cathode. As used herein, “high voltage” means 120-150 kV. The invention only requires a DC power supply of only 12 V or 24 V. A single HV power supply is the only power source for the neutron generator. The Deuterium (“D”) ions are accelerated up to 120-150 kV and bombard the T-target. The nuclear reaction produces fast neutrons (around 14 MeV). A Deuterium-ion beam at the mili-Amp level can produce a neutron yield up to 10⁹ n/second.

The neutron generator of the invention uses field ionization instead of electron ionization in hot cathode or cold cathode ion sources, or Radio-Frequency (“RF”) ionization in RF sources. In one embodiment, CNT or other nanorods are used to generate the high electric field necessary for field ionization of Deuterium. In another embodiment, tungsten multi-tips are utilized to generate the high electric field necessary for gas phase field ionization of Deuterium. At least one of a CNT, NR, or multi-pin tungsten anode is utilized in accordance with the invention. The tungsten tips have a shank diameter of around 80 micrometer with a tip radius of around 100 nanometers (“nm”). This kind of field ionization with tungsten tips is used as ion source at nA level for mass-spectrometry and desktop fusion devices. In the ion source design of this invention, CNT, NR or multi-tip field ionization is used for ion current at the mili-Amp level and then accelerated up to 125-150 kV to get a Deuterium-Tritium (“D-T”) fusion reaction at the T-target. The neutron yield of 10⁹ n/s is at the level of conventional commercial neutron tubes.

A single HV power supply is used for both ion generation and acceleration. In the acceleration process, we do not use any focusing and beam transport systems. The ion beam is allowed, in open geometry, to hit the T-target. This simple accelerator provides two advantages: avoided additional power supply for beam optics and reduced beam power density at the T-target. Consequently, the beam heating is relaxed and the life-time of the neutron generator is increased. The lifetime is much longer than commercial neutron tubes due to the low power density at the T-target.

In some embodiments of the invention, the generator comprises a remote control. In specific embodiments, the remote control is integrated with the detection system for data collection and analysis.

The miniature neutron generator is small in size, but can deliver neutron yield comparable with commercial neutron tubes of 10⁹ n/second. The generator is small in size, light in weight, economic in power consumption, simple in operation and maintenance and low cost. In one embodiment, the miniature neutron generator is briefcase-sized, weighing less than 10 kilograms (“kg”) and having a battery power supply of 12 or 24 volts. This makes the device easy to carry.

We claim:

1. A neutron generator comprising:
a Deuterium gas filled chamber;
a high voltage power supply;
an field ionization ion source;
at least one of a CNT, NR, or multi-pin tungsten anode; and
a cathode.

2. The generator of claim 1, wherein the high voltage power supply is adapted to supply power between the anode and the cathode.

3. The generator of claim 1, wherein the cathode is a T-Ti thick target.

4. The generator of claim 1, wherein the field ionization source comprises at least one of CNT, NR, or tungsten multi-tips adapted to generate a high electric field.

5. The generator of claim 4, wherein the tungsten tips have a shank diameter of about 80 micrometers and a tip radius of about 100 nanometers.

6. The generator of claim 1, wherein the ionization source is a RF ionization source.

7. The generator of claim 1, further comprising a remote control.

8. The generator of claim 7, wherein the remote control is integrated with a detection system for data collection and analysis.

9. The generator of claim 1, wherein the generator weighs less than 10 kg.

10. A neutron generator comprising:
a Deuterium gas filled chamber;
a high voltage power supply of 125-150 kV;
an ionization source comprising tungsten tips;
an anode; and
a Tritium loaded Titanium thick target;
wherein the generator weighs less than 10 kg.

11. A method of detecting highly enriched Uranium associated with a target, the method comprising:
generating a field ionization of Deuterium by high voltage electric field;
providing an ion current;
accelerating the ions to hit the target to generate a Deuterium-Tritium reaction;
collecting the data; and
analyzing the data.

12. The method of claim 11, wherein the ion beam is accelerated up to 125-150 kV.

13. The method of claim 11, wherein the ion beam is accelerated up to 125-150 kV.

14. The method of claim 11, wherein the high voltage electric field is generated using a high voltage power supply.

15. The method of claim 11, wherein the high electric filed is generated using at least one of CNT, NR, or tungsten tips.

16. The method of claim 11, wherein the ion current is provided using field ionization.

17. The method of claim 11, wherein a neutron yield is up to 10⁹ n/second.

18. A method of detecting highly enriched Uranium associated with a target, the method comprising:
generating a high voltage electric field using at least one of CNT, NR, or tungsten multi-tips;
providing an ion current using a field ionization source;
accelerating the ion current such that the ion current hits the target to generate Deuterium-Tritium neutrons, wherein the ion current is accelerated up to 125-150 kV;
collecting the data; and
analyzing the data.
